(19) United States
(12) Patent Application Publication
(10) Pub. No.: US 2007/0193361 A1
(43) Pub. Date: Aug. 23, 2007

(54) Compressive load sensor by capacitive measurement

(75) Inventors: E. Michael Coffey, Bacliff, TX (US); Neil R. Davie, Livingston, TX (US)

Correspondence Address: Gregory M. Luck;Thompson & Knight, LLP, Suite 3400, 333 Clay St., Houston, TX, 77002, US

(73) Assignees: Davie/Coffee Technologies, LLC; dba TruTel Sealing Technology

(21) Appl. No.: 11/358,502

(22) Filed: Feb. 20, 2006

(51) Int. Cl. G01B 7/16

(52) U.S. Cl. 73/780

(57) ABSTRACT

A thin, flat capacitive load sensor, such as of layered sandwich construction, having a variety of shapes, so as to provide a seal between two or more opposing surfaces. The load sensor includes a thin first and second insulating outer layer between which an inner layer is secured. The inner layer can be formed of dielectric material of a known dielectric constant, with at least one thin electrical conductor to accommodate load sensing disposed against a first face, and another thin electrical conductor to accommodate load sensing disposed against a second face. Electrical conductors connect the thin conductive areas on the first and second faces to the distal end of a tab extending beyond the load or connection measurement area. The distal end of the tab accommodates a connection with electrical measurement apparatus. As the inner layer is compressed, the spacing between the electrically conductive areas on the opposing faces is decreased such that compressive forces can be measured as a function of the changes in capacitance of the sensor. In this manner, proper compression can be achieved by monitoring capacitance during installation. Follow-up sampling or continuous measurement of sensor compression provides early detection prior to failure to allow corrective action.

### RELATED APPLICATIONS

This application claims priority to Ser. No. 10/191,155, filed Jul. 9, 2002, which claims priority to 60/311,156, filed Aug. 10, 2001, both of which are commonly owned and which are hereby incorporated by reference for all purposes.

### FIELD OF THE INVENTION

The present invention pertains to the field of gasket condition monitoring, and more particularly to a system and method for gasket condition monitoring that utilizes capacitive sensors to determine the amount of compression on gasket material.

### BACKGROUND OF THE INVENTION

Gaskets are used in many industrial and consumer applications to provide a conformable seal between mating surfaces. The effectiveness of the seal achieved is a function of the proper selection of gasket material for surfaces being sealed and contents to be contained within the vessel or piping being sealed. Proper installation of the gasket, for instance by compression of the material, is necessary for a lasting seal to be effected.

Gasket applications include those required to contain liquids, gasses or solids where leakage could lead to emissions with detrimental effect to safety or the environment. Such applications include those where volatile organic compounds such as gasoline and carbolic acid, carcinogenic compounds such as benzene and toluene and poisonous compounds such as chlorine, phosgene, hydrogen cyanide and ammonia must be contained. Seal applications likewise includes those where insecticide compounds, defoliant compounds, ozone depleting gasses such as chlorinated hydrocarbons, or other dangerous compounds must be contained. The critical nature of the gasket seal in these and many other applications is such that an improved method of installation and verification of gasket integrity over time provides utility for safety and as a deterrent to fugitive emissions.

Connections between members without gasketing such as found in buildings, bridges, railroads, truck wheels, aerospace and many other applications likewise require assurance of proper initial connection integrity and early warning of connection failure. Both during normal use and especially as a result of collision, storm stresses and connection aging require ongoing monitoring means to provide a quick and inexpensive method to assess condition and maintenance action.

Existing approaches to achieving proper gasket compression, sealing and member connection include utilization of a torque wrench or other torque controlling device on bolts tightening flanges, stop rings as described in U.S. Pat. No. 2,196,953 issued to Bohmer et al, and measurement of applied forces to the gasket or connection through piezoelectric, resistive or other stress or strain responsive material. Gaenssle in U.S. Pat. No. 4,969,105 describes bolt torqueing which approximates the gasket compression effectiveness with a controlled bolt torqueing mechanism whereby the tensioning applied to a gasketed joint is controlled by the torque shutoff point of the mechanism. While an improvement over uncontrolled torqueing dependent on the skill and experience of the operator, perhaps even with a torque wrench, the bolt tension measurement approach contains many factors such as friction and lack of flange parallelism resulting in incorrect installation. The approach does not address gasket sealing without tensioning bolts. Similar problems exist in connections between members not carrying a gasket.

Several patents describe usage of piezoelectric or piezoresistive strain gauge sensors applied to their gasketing applications, such as U.S. Pat. No. 5,529,346 issued to Sperring, U.S. Pat. No. 4,686,861 issued to Morii, U.S. Pat. No. 4,566,316 issued to Takeuchi, U.S. Pat. No. 3,358,257 issued to Painter et al., and U.S. Pat. No. 3,036,283 issued to Singdale et al. Significant variations in measurements are commonly experienced with these sensors including non-linearity, vibration and temperature sensitivities. Common approaches to minimize these effects include arrangement in a four-unit bridge configuration to provide some common mode error cancellation and calibration and compensation circuitry. While these gasket sensors may work well within their intended applications, such additional elements and measurement complexities in addition to overall temperature limits and sensor fragility limit application to specific carefully designed uses.

Embedded resistive sensors composed of a polymer impregnated with conductive particles as described in U.S. Pat. No. 5,121,929 issued to Cobb and U.S. Pat. No. 5,581,019 issued to Minor et al suggest their usage as measurement means to be used during installation and subsequent monitoring activities. Such conductive material used as sensors in these patents have measured output variance from many factors, some of which are claimed for their gasket sensing purposes. Among these are changes due to compression, tension, temperature, breakage, change of shape and dielectric constant change. Dramatic variation of properties are also possible by slight manufacturing alterations and found useful for tailoring the material to a particular application. Unfortunately, in actual gasket usage, many of these sensed conditions, for instance temperature variations which in some cases reach 300 degrees C. or more, are normal operating conditions and variation of the intended gasket condition could be far overshadowed by unwanted measurement variations. Such variations would limit use to carefully controlled conditions in both the manufacturing of the material and the environment during gasket usage in order to maintain measurement accuracy.

Causes of gasket failure for instance between metal flanges, as in pipe joint application, include lack of parallelism of flange faces, uneven flange faces and improper bolt tightening, all leading to uneven spacing and hence uneven compression of gasket sealing material. In non-gasketed connections, incorrect spacing of connected members can occur for the same reasons. Too much compression can also lead to failure in gasketed connections due to material crushing and cold flow of the material over time.

The method to assure the effectiveness gasketing and valve seal applications has been addressed by U.S. Pat. No. 6,752,024 and U.S. Patent application Ser. No. ______ by the inventors of this invention. Certain gasketing and member connections, because of their physical configuration, however cannot make use of the approach described in the subject patents. It is a purpose of this invention to provide a means to extend the application of the capacitive sensor technology to those additional applications.

Therefore, what is needed to improve gasket and connection integrity is a sensor providing a correct measure of the conditions known to be factors affecting performance with minimal variations from tolerances, environmental variations or other factors unrelated to gasket or connection failure mechanisms.

### SUMMARY OF THE INVENTION

A gasket sensor is provided to effectively measure parameters for optimum installation and early detection of gasket or connection failure conditions, and to maintain measurement accuracy over the range of manufacture variations and environmental conditions.

The gasket sensor lends itself to a broad range of applications, through maximal use of existing gasket materials and design topologies so as to preserve the effectiveness achieved from years of development, refinement and field experience in those areas while enhancing the installation and monitoring of these gaskets and member connections. The sensing element and measurement methodology does not limit the environment in which the gasket sensor and connections are applied, such that they may be used in high temperature, high pressure and corrosive environments.

These and other purposes, advantages and objects of the present invention are realized by utilizing a capacitive sensor element in conjunction with appropriate dielectric insulators and layout topologies appropriate for the various gaskets and connections it is applied to. At least one, but more commonly a multiplicity of capacitive sensing elements are strategically placed adjacent to the gasket sealing or connection area to measure gasket compression or connection position at locations indicative of correct sealing or connection throughout the area of concern.

The capacitive sensor can be implemented utilizing a thin metallic or conductive layer forming a known area for measurement to a nearby metallic structure, typically the flanges, vessel or other structures that are used to compress and constrain the gasket or connected members. An electrical insulating material surrounds the capacitive sensor, which in one embodiment is an elastomer similar to the dielectric material used in the sensor itself. By controlling the sensor measurement area and dielectric constant, the distance between the metallic layer and the nearby structure can be determined, which is a function of the compression of the dielectric material of the capacitive sensor.

An electrical apparatus is used to sense the capacitance of the multiplicity of elements contained within the gasket or connection structure to provide an operator with initial compression information as to where and how much compression to apply. Subsequent measurements of the capacitance on a sampled or continuous basis as desired can be used to ensure gasket or connection integrity over time. A connection to a remote central monitoring station can also be provided.

### BRIEF DESCRIPTION OF THE DRAWINGS

FIG. 1 is a schematic illustration of a parallel plate capacitor arrangement that provides the basis for the capacitive load sensor in accordance with an exemplary embodiment of the present invention;

FIG. 2 is a plan view of a basic raised face flange in accordance with an exemplary embodiment of the present invention;

FIG. 3 is a profile view of a raised face flange in accordance with an exemplary embodiment of the present invention;

FIG. 4a depicts a plan view of a raised face flange with a graphite, corrugated or metal inlay type gasket in accordance with an exemplary embodiment of the present invention;

FIG. 4b is a plan view of the opposing metalized layer of the sensor, separated from 4a by a dielectric material.

FIG. 4c is a profile view of the sensor area of the above figures in accordance with an exemplary embodiment of the present invention;

FIG. 5a is a plan view of a spiral wound gasket and raised face flange in accordance with an exemplary embodiment of the present invention;

FIG. 5b is a profile view of the gasket and sensor configuration of 5a further depicting the placement of the flange, gasket and sensors in accordance with an exemplary embodiment of the present invention;

FIG. 6a is a solid metal ring joint gasket with a flat face flange in accordance with an exemplary embodiment of the present invention;

FIG. 6b is a profile view of the ring joint gasket, flange and sensor in accordance with an exemplary embodiment of the present invention;

FIG. 7 is a tongue and groove flange with a gasket inserted in the tongue and groove in accordance with an exemplary embodiment of the present invention;

FIG. 8a is a sensor for bolts with a precision bellville washer in accordance with an exemplary embodiment of the present invention;

FIG. 8b is a sensor for bolts with a flat washer in accordance with an exemplary embodiment of the present invention;

FIG. 9a is a flange set with hydraulic tensioners in accordance with an exemplary embodiment of the present invention;

FIG. 9b depicts a single hydraulic tensioner showing additional detail of reaction bar and control valve for sensor feedback control in accordance with an exemplary embodiment of the present invention;

FIG. 10 illustrates a signal-processing instrument provided as a dedicated microprocessor-based unit with communication capability in accordance with an exemplary embodiment of the present invention;

FIG. 11 illustrates a flowchart of the programmed functional operation of a personal computer or the signal-processing instrument of FIG. 10 in accordance with an exemplary embodiment of the present invention;

FIG. 12 illustrates a data communication link between a personal computer or signal-processing instrument in accordance with an exemplary embodiment of the present invention;

FIG. 13 illustrates the server system of the remote data center in accordance with an exemplary embodiment of the present invention;

FIG. 14 illustrates the organization of the server system of the remote data center in accordance with an exemplary embodiment of the present invention;

FIG. 15a illustrates a plan view of a sensor designed to measure distance to connecting members in accordance with an exemplary embodiment of the present invention;

FIG. 15b illustrates a profile view of the sensor of 15a in accordance with an exemplary embodiment of the present invention;

FIGS. 16a, 16b and 16c illustrate a compression load sensor layer plan views and cross section utilizing both a reference sensor and common return area in addition to the sensor area in accordance with an exemplary embodiment of the present invention;

FIGS. 17a and 17b illustrate plan and cross-section views of a sensor incorporating a reference sensor area outside the compression area in accordance with an exemplary embodiment of the present invention;

FIG. 18 illustrates a capacitance-measuring instrument for use with the compression load sensor and a reference sensor for the sensor of FIGS. 17a and b, including circuitry for correcting errors in the capacitive gasket compression sensor data in accordance with an exemplary embodiment of the present invention;

FIG. 19 illustrates a timing diagram explaining the operation of the circuitry of FIG. 18 in accordance with an exemplary embodiment of the present invention;

FIG. 20 illustrates a further capacitance-measuring instrument for use with the compression load sensor and reference sensor of FIGS. 17a and b which compensates for many error sources by its configuration in accordance with an exemplary embodiment of the present invention; and

FIG. 21 illustrates a timing diagram of the measurement circuit of FIG. 20 explaining its operation in accordance with an exemplary embodiment of the present invention.

### DETAILED DESCRIPTION OF THE PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

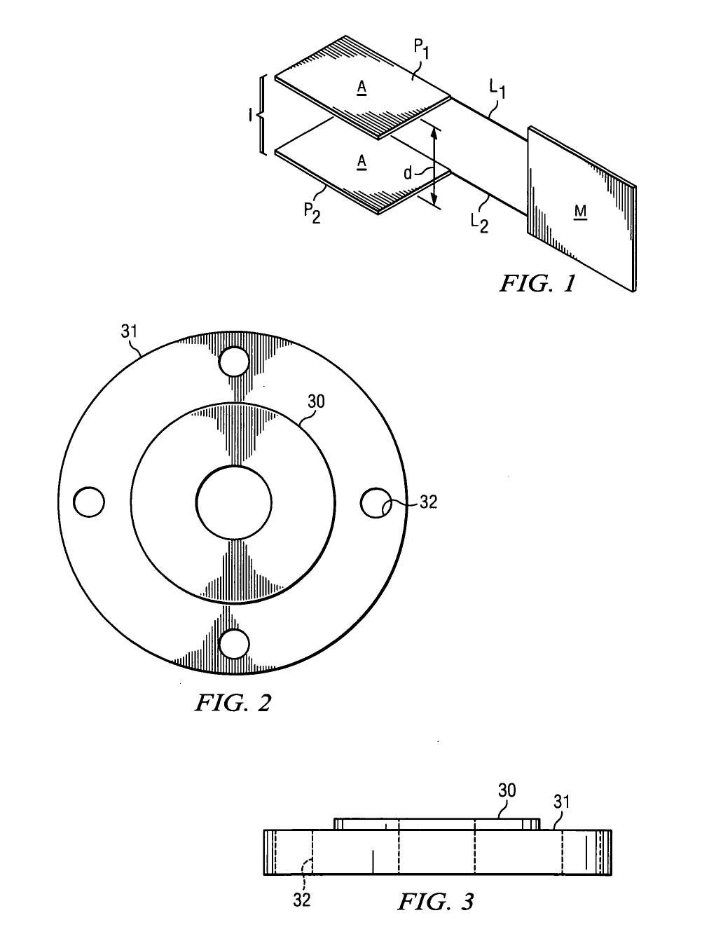

FIG. 1 is a schematic illustration of a parallel plate capacitor C that provides the basis for a capacitive load sensor in accordance with an exemplary embodiment of the present invention. Capacitor C includes two parallel plates P1 and P2 of equal area “A” formed of a metallic conductor with a dielectric material I between the plates. Dielectric material I has a dielectric constant “K,” whereas the dielectric constant for air is 1.0, such that the ratio of the capacitance of capacitor C to a capacitor with identical spacing and area using air as an insulator is “K.”

The parallel plates P1 and P2 area are shown connected via leads L1 and L2 to a measurement device M. The commonly known equation for capacitance between parallel plates is:

$${C}_{PP} = \frac{.224 KA ( N - 1 )}{D}$$

Where:

C=capacitance in picofarads

A=the area of the smallest parallel plate in square inches

K=the dielectric constant of material between plates

D=spacing between plate surfaces in inches, and

N=number of plates

From this relationship, it can be seen that the distance “D” can be readily determined by a measure of the capacitance if area “A” and dielectric constant “K” are fixed. Therefor, the amount of compression achieved at the capacitive sensor location can be determined for a particular configuration by controlling, within reasonable tolerances, the area “A” and dielectric constant “K”. The area “A” can be effectively made and maintained at close tolerances during manufacture of a sensor device by conventional etching operations commonly used in the flexible circuitry construction. The electrical conductors for connecting the leads of such a sensor device to the measuring device are also preferably narrow etched areas.

FIG. 2 is a plan view of a basic raised face flange in accordance with an exemplary embodiment of the present invention. Manufacturing methods and industry standards provide maximum parallelism between the raised face area 30 and the flange area 31. Bolt holes 32 are provided for assembly of two mating flanges with various gasket types interposed between, depending on the pressures and material being contained by the connection.

FIG. 3 is a profile view of a raised face flange in accordance with an exemplary embodiment of the present invention.

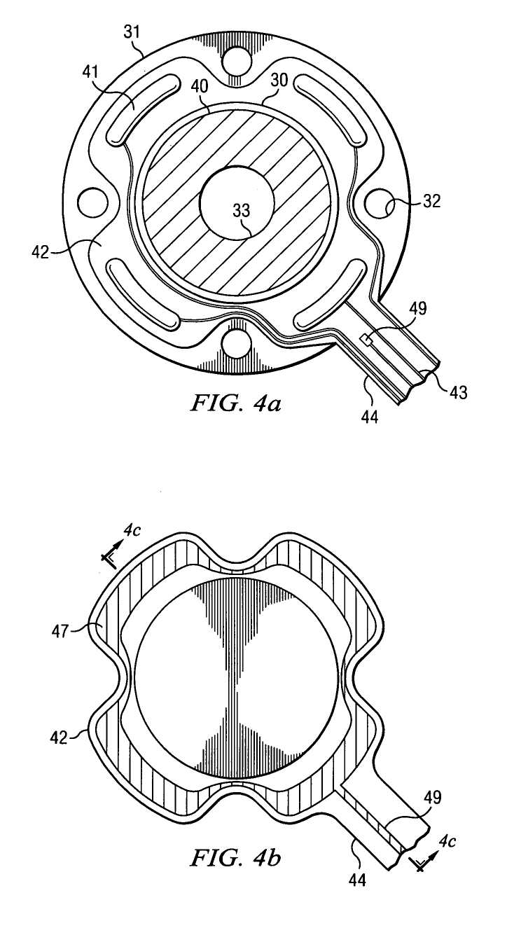

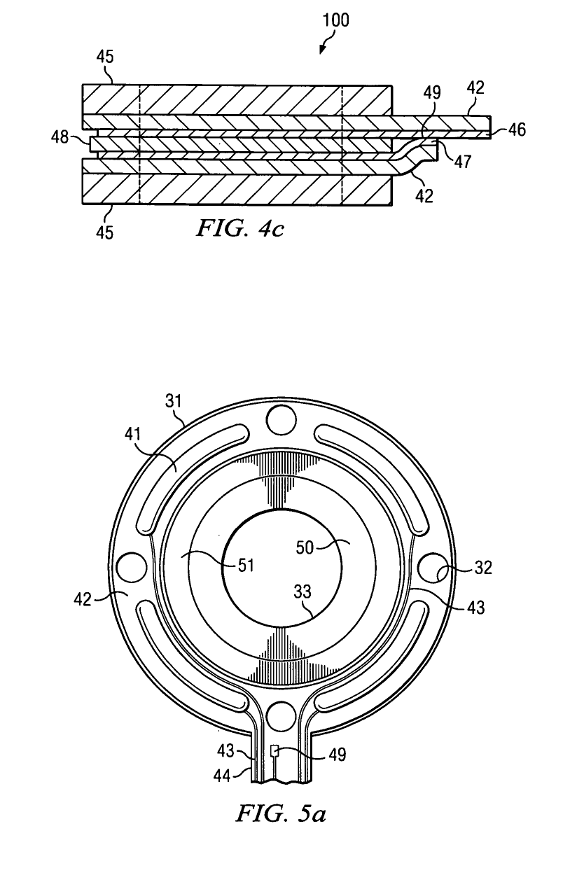

FIG. 4a depicts a plan view of a raised face flange with a graphite, corrugated or metal inlay type gasket 40 in accordance with an exemplary embodiment of the present invention. Certain types of gaskets commonly used in the industry do not lend themselves readily to inserting the sensor within the gasket itself, particularly those with uneven profiles and conductive material content. Gasket 40 of the graphite, corrugated or metal inlay type of gasket where the physical profile or conductive nature of the gasketing material are examples of such instances.

FIG. 4b depicts a plan view of the metalized sensor face opposing that of FIG. 4a, providing the second capacitance plate 47 for each of the sensor elements 41. Supporting backing material 42 is typically polyimide or polyester material commonly used in flexible circuit construction in about 2 mils thickness. Connection is made between metalized layers at 49 to facilitate measurement apparatus attachment by connector at the tab 44 distal end.

FIG. 4c is a profile view of the sensor area of the above figure in accordance with an exemplary embodiment of the present invention. The sensor metallic layers 46, 47, insulating and supporting layers 42 and dielectric layer 48 are surrounded by an additional material 45 providing additional thickness spacing to match the known mating flange gap. Either a solid or compressive insulating material can be used that provides a suitable range of sensor capacitance. The durometer of the compressive material 45 can be selected to provide the range of sensor sensitivity desired while still allowing the thickness tolerance range in the application.

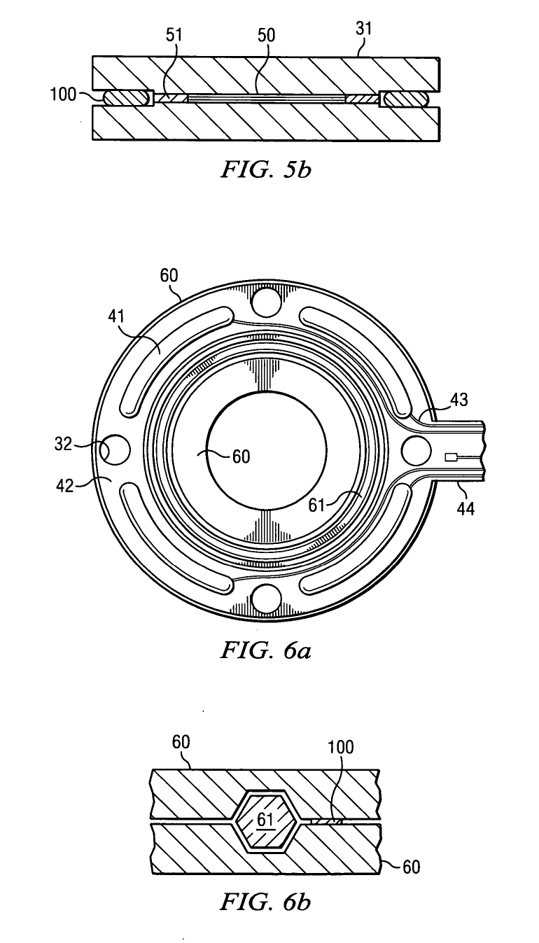

FIG. 5a is a plan view of a spiral wound gasket and raised face flange in accordance with an exemplary embodiment of the present invention. A gasket of the spiral wound type 50 surrounded by a metal ring 51 is provided to enhance the parallelism of the mating surfaces by providing a firm stop. Nevertheless, ring 50 does not always stay adequately concentric with sealing area 40, which encloses the product material 33. A multiplicity of sensor elements 41 are shown disposed outside the compressed sealing area, supported in place by a membrane 42, commonly of the same material as the insulating backing 14, 15 upon which the sensor metallic layers 19, 20 are attached. The sensor array thus formed is placed outside the raised flange 30 area but covered by the remaining flange area 31. A tab area 44, projecting beyond the flange area is provided for connection to measurement circuitry. Leads 43 from each sensor typically comprised of narrow, etched metallic layer in the same manner as the metallic components of the sensor make connection to the distal end of the tab. Connection to opposing metalized layer 47 is made at 49 in the same manner as in FIGS. 4a, 4b and 4c.

FIG. 5b is a profile view of the gasket and sensor configuration of 5a further depicting the placement of the flange, gasket and sensors in accordance with an exemplary embodiment of the present invention.

FIG. 6a is a solid metal ring joint gasket with a flat face flange in accordance with an exemplary embodiment of the present invention. In this exemplary embodiment, sensor 100 is disposed outside the sealing area. A metal ring joint gasket 61 commonly used for high pressure seals is disposed between two mating flanges, 60. A multiplicity of sensor elements 41 are shown held in place by the supportive carrier 42. The sensors 100 are used during installation to ensure parallelism between the mating flanges 60. Subsequent sampled or continuous monitoring of the sensor capacitance (compared to that at installation) provides a measure of seal integrity, with early warning of seal failure when changes are observed.

FIG. 6b is a profile view of the ring joint gasket 61, flange 60 and sensor 100 in accordance with an exemplary embodiment of the present invention.

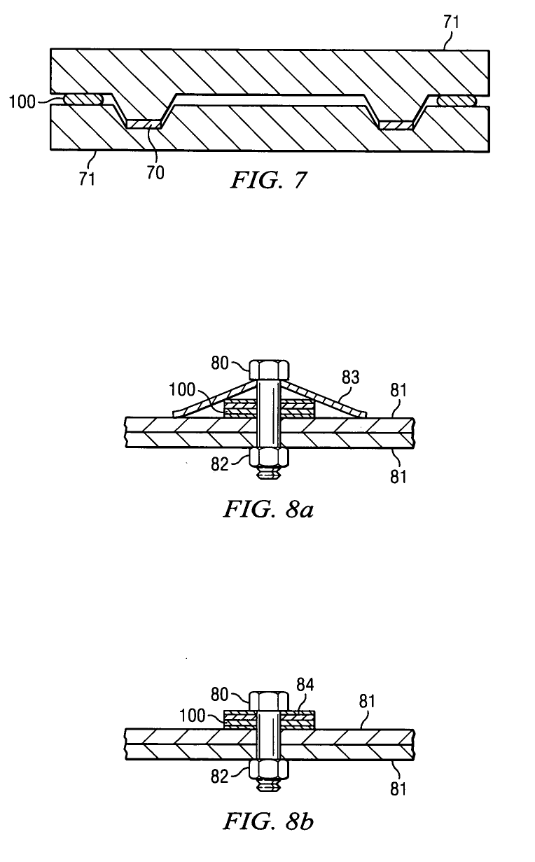

FIG. 7 is a tongue and groove flange with a gasket inserted in the tongue and groove in accordance with an exemplary embodiment of the present invention. A tongue and groove gasket 70 is disposed between two mating flanges 71 or other suitable faces that are to be joined. Again, maintaining parallelism of the mating flanges during installation and subsequent monitoring of the capacitance can be achieved to ensure the seal integrity.

FIG. 8a is a sensor for bolts with a precision Bellville washer 83 in accordance with an exemplary embodiment of the present invention. Sensor 100 is shown in a washer-like configuration to be used with bolts 80 and nuts 82 to achieve a connection between members such as the plates 81 shown. When used in conjunction with a Bellville washer 83, which has the appropriate force yield point, the sensor is compressed upon correct bolt tension. Sensor 100 can be periodically or continuously measured, as in the prior examples.

FIG. 8b is a sensor for bolts with a flat washer 84 in accordance with an exemplary embodiment of the present invention. When a flat washer 84 is used in the bolting assembly, sensor 100 provides a direct measure of the bolt tension applied. The durometer, or compressibility, of sensor 100 is chosen such that an indication at the desired bolt tension or stretch is within the dynamic range of the sensor. When assembled in this manner, an early warning of connection looseness, abnormal forces due to collision or other damage, and dynamic force changes can be obtained. Building structures, bridge members, critical automotive components, airplane and aerospace structural members, other suitable connections can be monitored as often as desired, in a timely manner and with considerably less effort than would be required for manual measurements. The ability to dynamically measure the connection integrity during operation in various environments can be useful in testing and analysis if failure occurs.

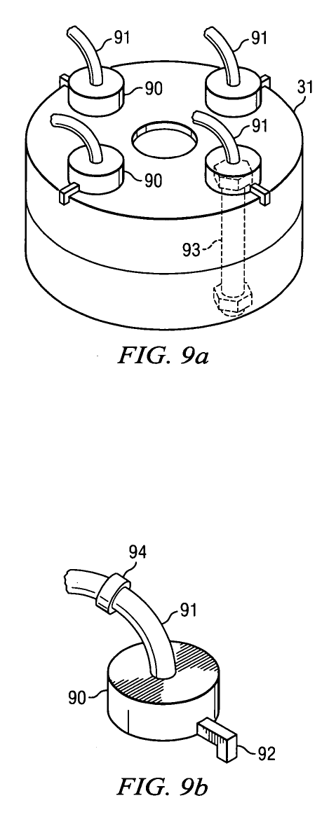

FIG. 9a is a flange set with electrically driven or hydraulic tensioners 90 in accordance with an exemplary embodiment of the present invention. Tensioners 90 can be used in flange bolting procedures, with equal pressure applied to each tensioner to provide for approximately equal torque to each respective bolt 93 being tightened. A reaction bar 92 is used in such devices to prevent rotation of the tensioner. A wrench or other tool is used on the nut to prevent rotation during installation procedures. However, bolt friction, lack of flange parallelism and flange unevenness can result in inadequate sealing of the gasket interposed between the mating flanges 31. When used in conjunction with a multiplicity of sensors as herein described, measured by measurement devices, and subsequently used as a feedback mechanism via a proportional control valve to each tensioner, bolts can be tightened to the correct tension to provide proper seal at the gasket. Inability to achieve a proper compression over the seal area, for instance due to a severely cocked flange member, can be detected to allow corrective action to be taken at installation. Subsequent monitoring capabilities beyond installation can be achieved, the same as with manually tightened bolt procedures. Sensor compression can be used in combination with existing methods of bolt stretch, torque or other methods where synergism exists to provide the proper installation.

FIG. 9b depicts a single hydraulic tensioner showing additional detail of a reaction bar and a control valve for sensor feedback control in accordance with an exemplary embodiment of the present invention. The leads 43 of the load sensors are connected to an electrical measurement apparatus sensitive to the sensor capacitance and subsequently connected to an electrical apparatus capable of storing and displaying the measurement data, such as a portable personal computer. The measurement apparatus provides a measure of the spacing between the metallic or conductive sensors separated by the dielectric and thus the seal or connection compression. The measurement apparatus is also used to present the measured values in a manner most needed by an installer or monitoring personnel. Use of the conventional computer connectivity facilities, for example, a Universal Serial Bus (USB), allows a multiplicity of circuit nodes to be connected to the same input of a computer. Power to the load sensor can be provided over the connecting cables of the USB, or in the case of a wireless connection, primary battery power can be provided. Further monitoring capability can be easily implemented using a modem or local area network connection from the computer to a centrally located monitoring station at a facility where continuous or sampled monitoring is desired. Use of an IEEE 802.11b standard is one example of a wireless local network commonly found on laptop computers as a means to facilitate such a central monitoring facility without the necessity for running interconnecting lines between units.

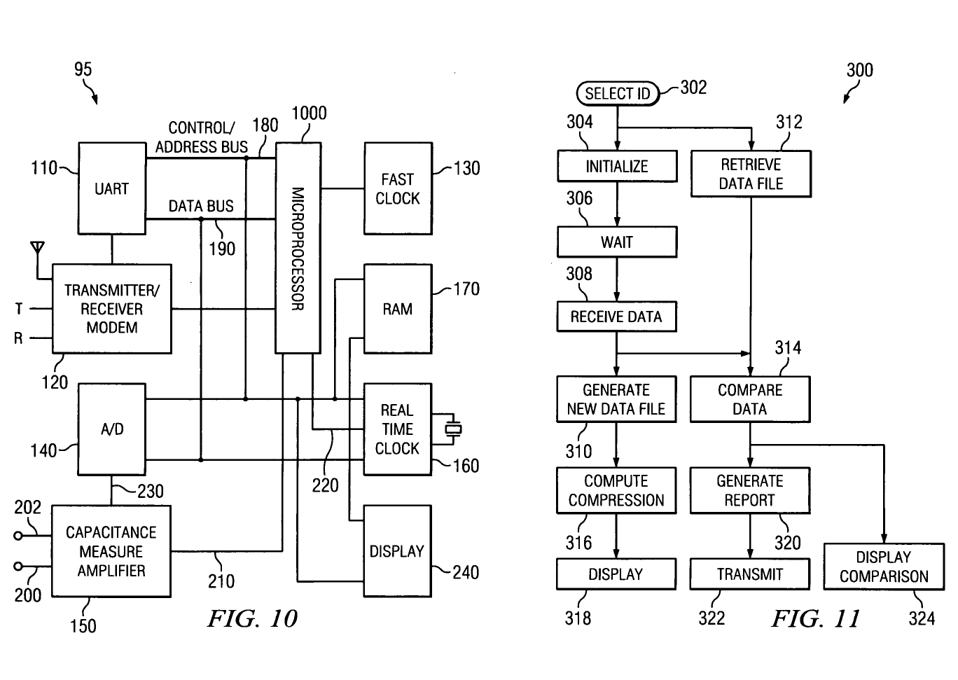

FIG. 10 illustrates a signal-processing instrument provided as a dedicated microprocessor-based unit with communication capability in accordance with an exemplary embodiment of the present invention. Dedicated microprocessor-based unit 95 provides monitoring functions without requiring a processor having all the capabilities provided by a personal computer. Such a signal-processing instrument can provide for gasket and connection integrity data collection, data storage, and data display and data transmission over a communication link. Instrument 95 includes conductors 200 and 202 for connecting to the capacitor plates of any of the sensors depicted herein. The conductors connect the capacitor plates to a capacitor measuring circuit and amplifier 150. Circuit 150 may also be provided as a separate unit. The capacitance measurement is applied to an analog-to-digital (A/D) converter 140 coupled to data bus 190. Also coupled to data bus 190 are microprocessor 1000, RAM 170, display 240, universal asynchronous receiver transmitter (UART) 110, and real time clock 160. Control/address bus 180 also interconnects those components as shown. UART 110 provides formatted data to the transceiver unit 120. Transceiver unit 120 includes a modem for connection to the tip (T) and ring (R) lines of a telephone circuit. Transceiver unit 120 also includes a wireless communications capability. Instrument 95 can be packaged as a portable, battery-powered unit for handheld operation by field personnel.

FIG. 11 illustrates a flowchart 30 of the programmed functional operation of a personal computer 82 along with measurement circuitry 150 and A/D 140 or signal-processing instrument 95 in accordance with an exemplary embodiment of the present invention. After the select ID block 302 makes an identification of the particular sensor, the capacitance-measuring instrument is initialized at block 304. A period of time is allowed at block 306 during which time the capacitance measurement is made. The data is received at block 308. The received data is used to create a new data file at block 310. If the sensor has already been installed such that there is an existing data file, the file was received at block 312 after the select ID operation. The retrieved data is provided to block 314, which also is provided with the received data at block 308. After a new data file is generated, the sensor compression is computed at block 316. This computation is done on the basis of the equation for capacitance from which the distance “d” parameter is derived. The distance “d” parameter is then used in accordance with a stored look-up table to determine the sensor compression. The computed compression is displayed at block 318. The flowchart also shows that based on the data comparison at block 314, a report is generated at block 320 and transmitted at block 322. Also, the data comparison is displayed at block 324. Signal processing instrument 95 can be packaged in a handheld device similar to a personal digital assistant (PDA) or a similar portable data entry instrument.

Through calibration of the capacitance-measuring instrument, a display of the measured capacitance signal can be provided on either a personal computer or instrument 95 of sensor compression forces in predetermined units of measurement. The display can be used by the gasket or connection installer for guidance in properly installing the gasket or connecting hardware. Further, a data file record can be made of the sensor installation parameters for archival purposes. Such a data file record can be transmitted over a communication link to a central data center. In addition, field maintenance personnel can use either a personal computer or instrument 95 to monitor gasket or connection integrity and performance during periodic maintenance. This determination can be made by personnel in the field using a locally stored database, by transmission to a central monitoring station where the data is analyzed, or in other suitable manners. In a bi-directional communications link between the field unit (personal computer or instrument 95) and a central monitoring station, sensor performance data can be returned to field personnel. Suitable communications links, such as a telephone line, a wireless connection, an Internet connection, a fiber optic connection, or other communications media or combinations of communications media can be utilized.

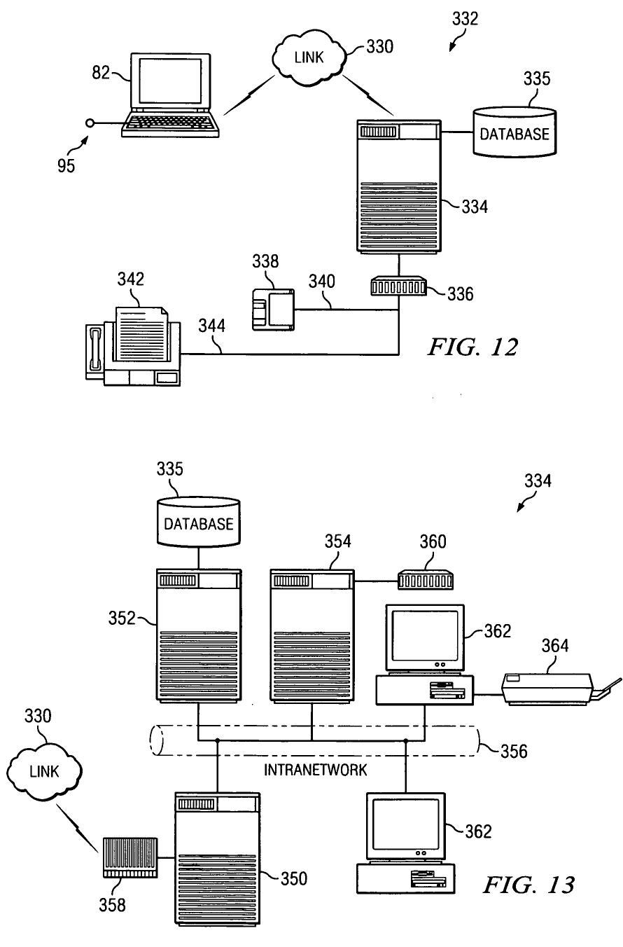

FIG. 12 illustrates a data communication link between a personal computer or signal-processing instrument in accordance with an exemplary embodiment of the present invention. A sensor is connected to capacitance measuring instrument 95, which can be interfaced to a personal computer. Capacitance measurement data for the sensor is stored as a set of collected measures stored as data files for later retrieval. The data files are telemetered over a communication link 330 to remote data center 332. The telemetered data files received at the data center are analyzed by server system 334, which includes a database 335. The feedback can then be provided back to the field personnel evaluating the gasket or connection integrity through a variety of media. By way of example, the feedback can be sent as an electronic mail message generated automatically by the server system 334 for transmission over the communication link 330. The electronic mail message is received by a personal computer or instrument 95. Alternately, the feedback can be sent through a telephone interface device 336 over phone line 340 or as an automated facsimile message to a facsimile machine 342 over phone line 344, both also situated for local access by field personnel. In addition to a personal telephone 338 and facsimile machine 342, feedback can be sent to other related devices, including a network computer, personal data assistant, television, or digital data processor.

FIG. 13 illustrates server system 334 of the remote data center in accordance with an exemplary embodiment of the present invention. Server system 334 includes three individual servers: network server 350, database server 352, and application server 354. These servers are interconnected via network 356. In the described embodiment, the functionality of server system 334 is distributed among these three servers for efficiency and processing speed, although the functionality could also be performed by a single server or cluster of servers. Network server 350 is the primary interface of server system 334 to link 330. Network server 350 receives the collected data files that are telemetered from the field over link 330. Network server 350 is interfaced to link 330 through router 358. To ensure reliable data exchange, the network server 350 preferably implements a TCP/IP protocol stack, although other suitable network protocols can also or alternatively be used.

Database server 352 organizes the data files in database 352 and provides storage of and access to information held in those files. A high volume of data in the form of collected measure sets from individual sensors is received. Database server 352 frees the network server 350 from having to categorize and store the individual collected measure sets in the data files. Application server 354 operates management applications and performs data analysis on the stored data files in developing gasket or connection integrity records. Application server 354 communicates feedback to the field personnel, such as through electronic mail over link 330 via network server 350, as automated voice mail or facsimile messages through telephone interface device 360, or in other suitable manners.

Server system 334 may also include a plurality of individual workstations 362 (WS) interconnected to network 356, which can include peripheral devices, such as printer 364. Workstations 362 can be used by data management and programming staff, office staff, consultants and other suitable personnel.

Database 335 can include a high-capacity storage medium configured to store individual sensor data files and related installation information. Database 335 can also or alternatively be configured as a set of high-speed, high capacity hard drives, organized into a Redundant Array of Independent Disks (RAID) volume, or in other suitable configurations. However, any suitable form of volatile storage, fixed storage, sequential access storage, permanent storage, erasable storage, or other storage can be used.

The individual servers and workstations of the remote center can be general purpose programmed digital computing devices consisting of a central processing unit (CPU), random access memory (RAM), non-volatile secondary storage, such a hard drive or CD ROM drive, network interfaces, and peripheral devices, including user interfacing means, such as a keyboard and display. Program code, including software programs, and data are loaded into the RAM for execution and processing by the CPU and results are generated for display, output, transmittal, or storage.

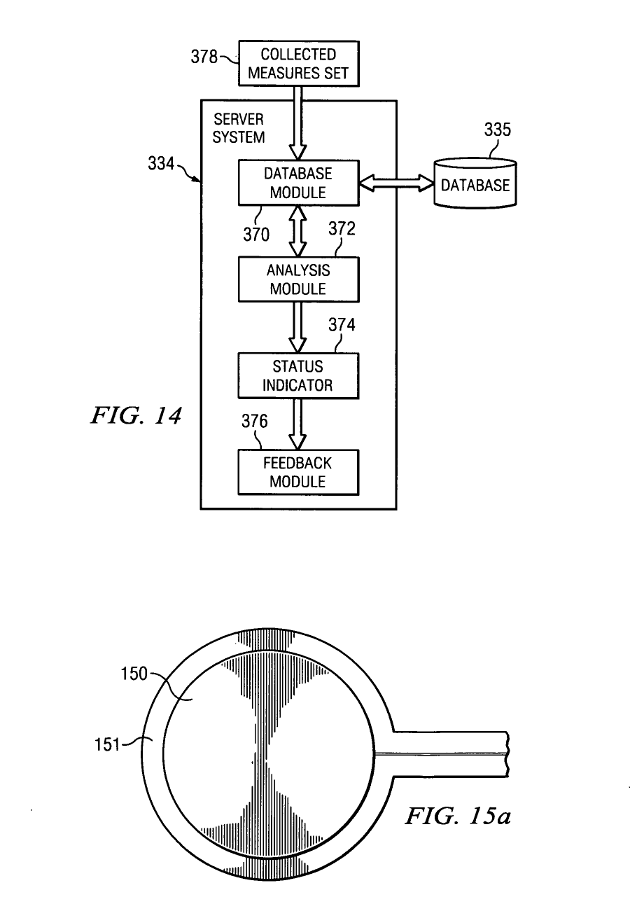

FIG. 14 illustrates the organization of server system 334 of the remote data center in accordance with an exemplary embodiment of the present invention. Each module can be a computer program written as source code in a conventional programming language, such as the C or Java programming languages, and presented for execution by the CPU as object or byte code, as is known in the arts. There are four exemplary software modules, which functionally define the primary operations performed by the server system 334: database module 370, analysis module 372, gasket or connection status indicator 374, and feedback module 376. In the described embodiment, these modules are executed in a distributed computing environment, although a single server, a cluster of servers, or other suitable configurations can also provide the functionality of the modules.

For each gasket or connection being installed or monitored, server system 334 periodically receives a data file comprising a collected measure set 378 which is forwarded to database module 370 for processing. Database module 370 organizes the individual gasket or connection records stored in the database 335 and provides the facilities for efficiently storing and accessing the collected measure sets 378 and gasket or connection data maintained in those records. Any suitable type of database organization can be utilized, such as a flat file system, hierarchical database, relational database, or distributed database. Analysis module 372 analyzes the collected measure sets 378 stored in the gasket or connection data files of database 335. Analysis module 372 makes an automated determination of gasket or connection integrity in the form of a status indicator 374. Collected measure sets 378 are received from the field and maintained by database module 370 in database 335. Through the use of this collected information, analysis module 372 can continuously follow the integrity of the gasket or connections monitored by the sensors over the course of its maintenance history and can analyze the data to detect any trends in the collected information that might indicate a defect and warrant replacement. Analysis module 372 compares individual measures obtained from both the database records for the individual sensor and the records for a specific group of sensors.

Feedback module 376 provides automated feedback to the field concerning an individual gasket or connection, based in part on the individual gasket or connection status indicator 374. As described above, the feedback can be by data feed, electronic mail, automated voice mail, facsimile, or other suitable processes. In the described embodiment, four levels of automated feedback are provided. At a first level an interpretation of the status indicator 374 is provided, such as by a first feedback module. At a second level, a notification of a potential defect concern based on the status indicator 374 is provided, such as by a second feedback module. This feedback level could also be coupled with human contact by specially trained technicians or engineering personnel. At a third level, the notification of defect concern is forwarded to field personnel in the geographic area of the gasket or connection installation, such as by a third feedback module. Finally, at a fourth level, a set of maintenance instructions based on the status indicator 374 can be transmitted directly to the field personnel directing them to modify the gasket or connection in some manner, such as by a fourth feedback module. As used herein, a module can be implemented in hardware, software or a suitable combination of hardware and software, and can be one or more software applications that work alone or in combination with other software applications.

The functionally of server system 334 can be provided in a software program resident on a personal computer. A database of gasket or connection data files can be stored on the hard disk of the computer or provided on a floppy disk or compact disk. The collected measure set processed from data obtained from the capacitance-measuring instrument can be analyzed by an analysis module to generate a status indicator. Feedback to the field maintenance personnel can be provided by a feedback module, and the collected measure set can be transmitted to the remote data center for archiving.

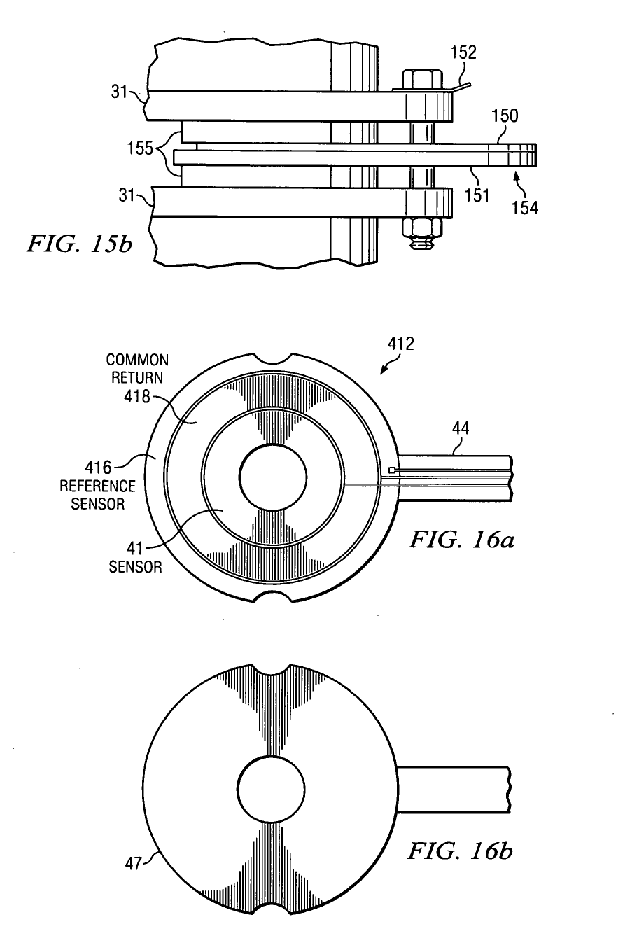

FIGS. 15a and 15b illustrate plan and profile views of a single element sensor designed to measure distance to connecting members in accordance with an exemplary embodiment of the present invention. A load sensor as described herein contains one or more sensor areas with capacitance to at least one of the metallic flanges 31 providing a measure of spacing to the flanges. Sensor carrier 151 can be constructed of a material such as polyimide commonly used in flexible circuit manufacture or other suitable materials, and retains the metallic sensor layer 150 along with its lead projecting to the distal end of the tab 154 for connection to measurement apparatus. The other measurement apparatus lead connects in a suitable manner, such as connection 152 shown to a flange. Insulating carrier 155 provides a range with a known dielectric constant, k, for calculation of the spacing, d, of the sensor between the two flanges. This configuration offers simplicity in sensor design through the use of a flange as a capacitor plate at the expense of more complicated connection to measurement circuitry.

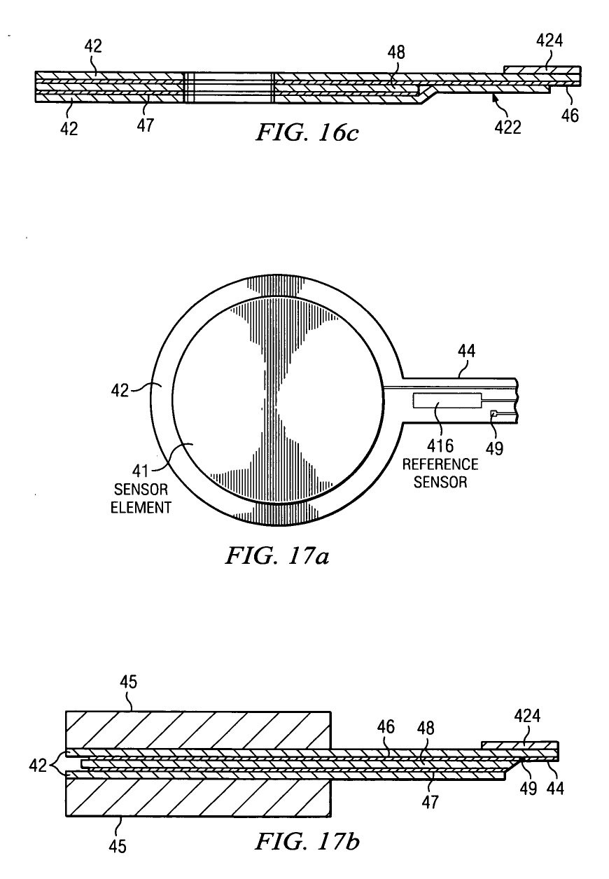

FIGS. 16a, 16b and 16c illustrate a compression load sensor layer plan views and cross section utilizing both a reference sensor and common return area in addition to the sensor area in accordance with an exemplary embodiment of the present invention. Reference sensor element 41, shown with one, but could be a multiplicity of sensor elements, is located in the area surrounding the compressed area. Layer 47 is located on the opposite side of dielectric 48 from sensor and reference sensor layer 46. A common return area is capacitively coupled to layer 47, thus providing a path with its lead to the tab 44 for connection along with sensor and reference sensor leads to measurement apparatus.

FIGS. 17a and 17b illustrate plan and cross-section views of a sensor incorporating a reference sensor area outside the compression area in accordance with an exemplary embodiment of the present invention. In this embodiment, reference sensor 416 is located in the tab area. The capacitively coupled return is not required to make an electrical connection, since a lead from layer 47 is connected by soldering, welding, ultrasonic bonding or other means at location 49 to the conductive lead on the sensor layer 46 leading to connecting tab 44 and subsequently the measurement apparatus. A stiffener 424 can be used at the back of connecting tab 44 to provide mechanical strength and correct thickness for insertion of a connector over the tab end. Material 45 can be an additional compressive layer, if needed, to increase the range of compression. The durometer, or compressibility, of these layers is selected to provide a thickness reduction in a known ratio with the thickness reduction in dielectric 48.

Tolerances in materials and measurement circuitry can result in error tolerances in some cases. For instance, over a wide temperature range a slight change in the dielectric constant can occur in most materials. Additionally, some initial variations in dielectric thickness can result from adhesive thickness or other factors in manufacturing the layers that make up the sensor. In electrical circuitry, stray capacitance in measurement leads and semiconductor junction capacitance can lead to changes in value. With a digitized data collection mechanism, these errors can be partially cancelled out through a calibration measurement that can be applied to each measurement made. Over time and environmental conditions, however, such initial calibration can become less accurate as values of junction capacitance vary and material properties change slightly.

Providing a reference sensor having the same variations as the load sensor affords a normalizing correction for the sensor reading. One correction technique is to divide each sensor measurement by the value of the reference sensor measurement. In this manner, a 10% variation to the capacitive compression load sensor output caused by the aforementioned variables will also result in a 10% variation in the reference sensor output. The corresponding variations result in cancellation of the error. The reference sensor can be positioned outside the compression area or in other suitable locations. Consequently, the reference sensor output would not change as the sensor is compressed. Prior to applying compression to the sensor and the associated gasket or connection, the measured value of capacitance to the reference sensor and the load sensor(s) can be approximately equivalent to their relative plate areas. As compression of the sensor(s) occurs, the compression load sensors increase in capacitance due to the decrease in spacing distance “d” in the capacitance formula. The reference sensor value remains unchanged except for any change in material or circuit characteristics, and subsequently cancels out the error produced by circuit or material characteristics.

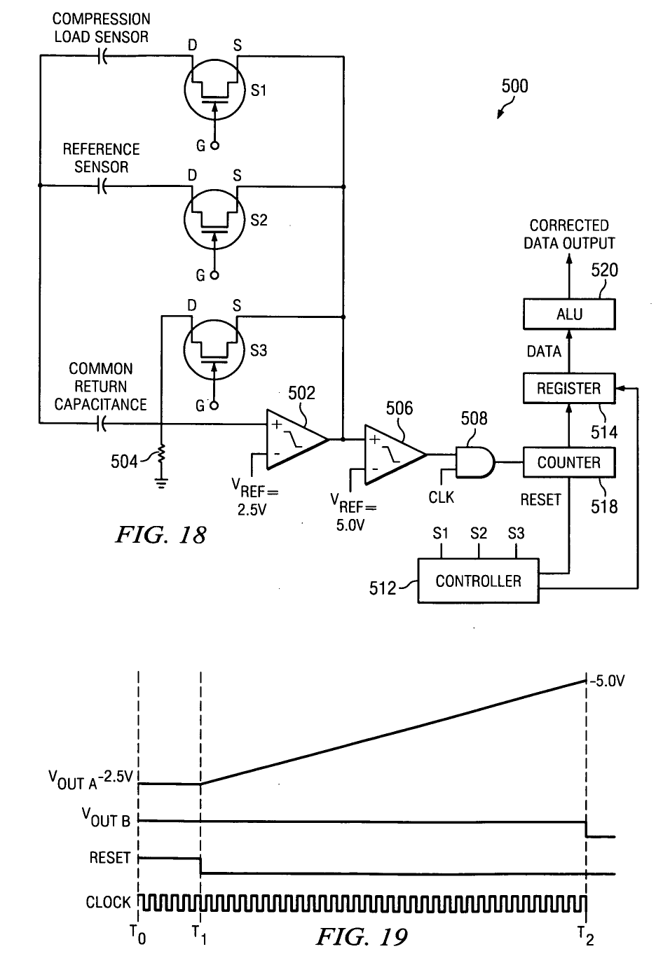

FIG. 18 illustrates a capacitance-measuring instrument for use with a compression load sensor and a reference sensor, including circuitry for correcting errors in the capacitive gasket compression sensor data, in accordance with an exemplary embodiment of the present invention. Circuit 500 is shown connected to a capacitor identified as the compression load sensor and to a capacitor identified as the reference sensor. Also shown is the series connected capacitance provided by the common return. The load sensor capacitor and the reference capacitor are connected in the feedback loop of an operational amplifier 502. Each of the load sensor capacitors and reference capacitor is connected in series with a FET switch identified, respectively, as S1 and S2. Another FET switch S3 is also connected in the feedback loop of operational amplifier 502. A resistor 504 is connected to the negative input of operational amplifier 502. The positive input of operational amplifier 502 is connected to a voltage reference source Vref=2.5 volts. Resistor 504 provides a constant current input to operational amplifier 502 according to I=Vref/R. The output of the threshold detector 506 is provided as a gating input to AND gate 508 to control the passing of clock pulses to counter 510. Controller 512 provides a control input for the switches S1, S2 and S3 and a reset control to the counter. Controller 512 provides a control input to register 514, which provides capacitance measurement data at its output. The data available from register 514 is made available for display driver (not shown) or to data processing facility such as a personal computer.

FIG. 19 illustrates a timing diagram explaining the operation of circuit 500 in accordance with an exemplary embodiment of the present invention. Switch S3 is closed prior to measurement. A measurement begins at T1 when S3 opens and one of the switches S1 or S2 is closed. Operational amplifier 502 acts as an integrator to provide an integral of its input at the output, VₒᵤₜA. Thus, the voltage at the output of operational amplifier 502 ramps toward an upper voltage limit in response to the constant current input. When VₒᵤₜA reaches the voltage threshold limit of threshold detector 506, the output VₒᵤₜB has a transition from a high voltage to a low voltage. The voltage output levels correspond to logic levels used in digital circuits. During the time of measurement, a clock is running to provide clock pulses to counter 518. However, when the threshold detector 506 goes to a low logic level at T2, AND gate 508 no longer pulses through to the counter. The amount of time that it takes for VₒᵤₜA to reach the detection threshold of threshold detector 506 is a function of the measured capacitance value of the compression load sensor. The count value data is transferred to register 514 to be read as the capacitance measurement data. The register can be configured to store measurements from both or only one of the sensors. The data is provided to circuit 520 such as an arithmetic logic unit (ALU) to perform mathematical operations such as dividing the measured capacitance of the compression load sensor by the value of the reference sensor capacitance. The compression load sensor value then becomes a measurement that is free from errors from such sources as operational amplifier leakage current and parasitic capacitance. The ALU produces corrected capacitive sensor output values.

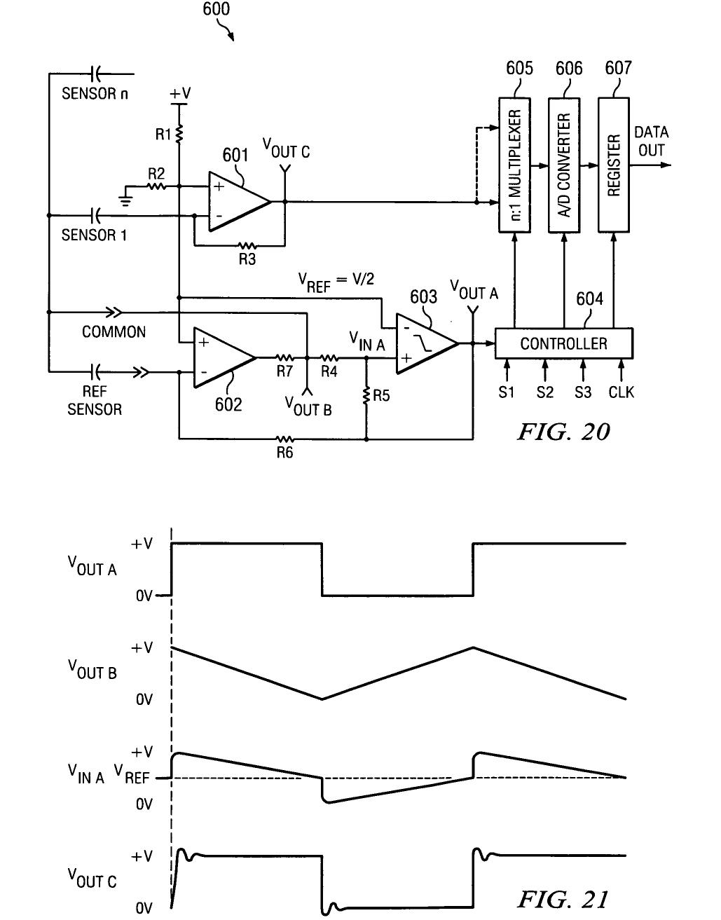

FIG. 20 illustrates a further capacitance-measuring instrument for use with the compression load sensor and reference sensor, which compensates for many error sources by its configuration in accordance with an exemplary embodiment of the present invention. Circuit 600 is configured to receive inputs from one or more load sensor inputs, Sensor1-n and a reference sensor input. The circuit is configured to provide normalization of the error factors discussed above automatically through the circuit's operation without digital ALU operations. In operation, operational amplifier 602 in conjunction with comparator 603, resistors R4 through R7 and the reference sensor capacitance form a multivibrator. Operational amplifier 602, with the reference sensor capacitance in its negative feedback path, forms an integrator. R7 is low valued, primarily for short circuit protection of operational amplifier 602 output and as such has very little effect on the circuit. R4 and R5 provide in conjunction with comparator 603, with the feedback through R5 to the positive input form a threshold detector with hysterisis. When the value of signal output from the operational amplifier 602 integrator reaches the upper or lower threshold value of the threshold detector of comparator 603, comparator 603 output changes state to a high or low logic level respectively. The resultant comparator 603 output waveform at VₒᵤₜA is a squarewave.

Comparator 603 is chosen to have logic output levels very close to the positive voltage supply and ground levels. The positive input to operational amplifier 602 is a voltage reference, V_{ref}, of approximately half the supply voltage, thus allowing maximum dynamic range of operation by operational amplifier 602. The negative input is held at the voltage reference value by the feedback, so a constant current input is applied through R6 by comparator 603 output VₒᵤₜA according to I=[(VₒᵤₜA)−V_{ref}]/R6. The constant current input to the integrator formed with operational amplifier 602 and the reference sensor capacitor results in a ramp output until the threshold detector level is reached and the VₒᵤₜA level then changes to the opposite logic level, which causes the integrator to begin ramping in the opposite direction as shown as VₒᵤₜB in FIG. 21, forming a sawtooth waveform.

FIG. 21 illustrates a timing diagram of measurement circuit 600 explaining its operation in accordance with an exemplary embodiment of the present invention. The signal waveform at the positive input to comparator 603, VᵢₙA, is a combination of inputs from VₒᵤₜA through resistor R5 and VₒᵤₜB through resistor R4. The threshold reference is shown as V_{ref}, the same as for operational amplifier 602, but any reference allowing an adequate dynamic range of circuit operation would be acceptable. VₒᵤₜB provides a sawtooth waveform to the common connection (the metalized layer opposite dielectric from the sensor and reference sensor layer) and thus provides an input signal to Sensor 1 through Sensor N, which have their opposite capacitive leads connected to a multiplicity of operational amplifiers 601, respectively (only one operational amplifier 601 is shown). Operational amplifier 601 has V_{ref} as a positive input voltage reference, again to allow maximum dynamic range between power supply levels. Sensor 1 capacitance in conjunction with resistor R3 as negative feedback to the operational amplifier 601 negative input, form a differentiator. The output of the differentiator is the derivative of its input. The resulting waveform at operational amplifier output VₒᵤₜC with a sawtooth input is a square wave, of a value proportional to the relative values of the reference capacitor and Sensor 1. As shown in the timing diagram, VₒᵤₜC may have slight overshoot and ringing as a result of various circuit parasitics, particularly those limiting bandwidth of the operational amplifiers 602 and 601. Minimization of the effects can be achieved by providing low pass filtering to locations in the signal path. One such location is provided by R7 in addition to its short circuit protection duty. A small value of capacitance across resister R3 would additionally provide the desired low pass filtering. The signal VₒᵤₜC is passed through a multiplexer switch 605 to analog-to-digital converter 606 (A/D) when selected by controller 604 addressing, shown as S1 through S3. A clock signal is provided for timing of A/D and register operations to sample the signal VₒᵤₜC after a delay, adequate to allow settling of the square waveform and A/D setup operations. The digitized relative capacitance value is then passed to a register 607 for storing or transmission to further processing and subsequently storing activities as previously discussed.

Although specific embodiments of the invention have been set forth herein in some detail, it is to be understood that this has been done for the purposes of illustration only and is not to be taken as a limitation on the scope of the invention as defined in the appended claims and the breadth of the disclosure. It is to be understood that various alterations, substitutions, and modifications can be made to the embodiment described herein without departing from the spirit and scope of the invention as set forth in the appended claims.

What is claimed is:

1. A system for determining the integrity of a seal between first and second mating flange faces comprising:
a gasket disposed between the first and the second mating flange faces;
a capacitive sensor disposed between the first mating flange face and the gasket;
a capacitive measuring instrument connected to the capacitive sensor and the second mating flange face for measuring a capacitance between the capacitive sensor and the flange as a function of gasket compression; and
a display coupled to the capacitance-measuring instrument receiving the measured capacitance and generating and indicator of gasket compression.

2. The system of claim 1 wherein the capacitive sensor further comprises an array of capacitor plates, the plates being disposed at spaced-apart locations.

3. The system of claim 1 wherein the capacitive sensor further comprises a conductor extending from the capacitive sensor to a tab.

4. The system of claim 2 wherein the array of capacitor plates further comprises a plurality of conductors, each extending from one of the capacitor plates to a tab.

5. The system of claim 1 wherein the first and the second mating flange faces comprise a mechanical connection.

6. The system of claim 1 wherein the display comprises a computer coupled to the capacitance-measuring instrument.

7. The system of claim 6 wherein the computer is connectable to a data communication link.

8. The system of claim 1 wherein the display comprises a computer connectable to a data communications link for transmission of gasket integrity data.

9. The system of claim 8 wherein the data communications link comprises:
a network server interfaced to the data communications link to receive a set of collected measures from the computer, the set of collected measures comprising individual measures related to a particular gasket recorded by the computer;
a database server coupled to the network server and storing the collected measure sets into a gasket integrity record for the individual gasket;
an application server coupled to the database server for analyzing the collected measure sets in the gasket integrity record for the individual gasket to determine a status indicator.

10. The system of claim 9 wherein the application server provides tiered feedback over a feedback communications link to field maintenance personnel concerning gasket integrity, and further comprises:
a first feedback module communicating a notification of the status indicator;
a second feedback module communicating a notification of a potential defect based on the status indicator to on-site maintenance personnel;
a third feedback module communicating a notification of a potential defect based on the status indicator to maintenance personnel in local proximity to the individual gasket or connection; and
a fourth feedback module communicating a set of gasket modification instructions based on the status indicator.

11. The system of claim 1 wherein the display comprises a computer that processes the measured capacitance signal to provide gasket compression information.

12. The system of claim 11 wherein the computer further comprises:
a first module providing one or more measures related to a gasket recorded by the computer;
a database storing the one or more measures into an integrity record for the gasket;
a second module analyzing the integrity record for the gasket relative to one or more other measures stored in the database to determine a status indicator; and
a feedback module providing feedback to field personnel concerning a state of the gasket, said feedback including one or more of communicating an interpretation of the status indicator, communicating a notification of a potential defect based on the status indicator; and communicating installation modification instructions based on the status indicator for the gasket.

13. A system for determining the compression of a gasket comprising:
a capacitor plate sensor located between two flanges and outside a gasket sealing area;
a capacitance measuring instrument connected to the capacitor plate sensor and at least one of the two flanges, said capacitance measuring instrument producing a measured signal indicative of a capacitance between the capacitor plate sensor and one of the two flanges as a function of compression; and
a signal-processing instrument coupled to the capacitance-measuring instrument receiving the measured capacitance signal and computing a measure of compression for display.

14. A system for determining the integrity of a connection of two mating flange faces comprising:
a sensor disposed between the mating flange faces outside a connection area, said sensor including first and second parallel capacitor plates separated by a dielectric layer;
a capacitance measurement instrument connected to the capacitor plates, said capacitance measuring instrument producing a signal indicative of a measured capacitance between the capacitor plates as a function of the spacing of the plates; and
a display coupled to the capacitance-measuring instrument to receive the measured capacitance signal and provide readout of sensor compression.

15. The system of claim 14 wherein the sensor comprises first, second and third compression layers and wherein the first capacitor plate is disposed between the first and second compression layer and the second capacitor plate is disposed between the second and third compression layers.

16. The system of claim 14 wherein the sensor comprises first, second, and third compression layers and wherein the second compression layer comprises a dielectric material.

17. The system of claim 14 wherein the sensor further includes a connector comprising a tab at a peripheral edge of the sensor and a conductor extending from each of the capacitor plates to the tab.

18. The system of claim 14 wherein at least one of the capacitor plates further comprises an array of capacitor plate elements.

19. The system of claim 18 wherein the array of capacitor plate elements further comprises a tab at a peripheral edge of the array of capacitor plate elements and a conductor extending from each of the capacitor plate elements.

20. A system for determining the integrity of a sealed connection of mating flange faces, comprising:
a gasket having a spiral wound component and a guide ring;
two capacitor plate layers, each including a metallization layer, disposed outside the guide ring;
a dielectric layer disposed between the capacitor plate layers;
insulating layers spacing the capacitor plates between mating flanges;
a capacitance measuring instrument connected to the capacitor plates and producing a signal indicative of dielectric layer compression as a function of measured capacitance between the capacitor plates; and
a display coupled to the capacitive-measuring instrument to receive the signal and provide a readout indicative of a compression loading on the spiral wound component.

21. The system of claim 20 wherein the gasket is a graphite gasket, a corrugated gasket, a tongue and groove gasket, or a metal inlay type of gasket.

22. A system for determining the integrity of a sealed connection of mating flange faces, comprising:
a gasket for disposition between the mating flange faces;
an array of compression sensors and a reference capacitance sensor, where the reference capacitance sensor is configured for location outside an area of compression of the mating flange faces;
a capacitance measuring instrument individually connectable to the array of compression sensors and the reference capacitance sensor, said capacitance measuring instrument producing an output indicative of a measured capacitance of each compression sensor and of the reference capacitance sensor; and
a circuit coupled to the capacitance measuring instrument to receive the output for each compression sensor and the reference capacitance sensor, the circuit combining the measurement outputs of each compression sensor and the reference capacitance sensor to produce corrected compression sensor outputs.

23. The system of claim 22 containing a measurement circuit, comprising:
an operational amplifier used in combination with the reference capacitance sensor to form an integrator;
a comparator with positive feedback providing a threshold detector:
a connection between the integrator and the threshold detector in a loop constituting a multivibrator;
an integrator output, with its output being a sawtooth signal, connected to the common plate of the capacitive sensors in the array;
each capacitive sensor in the array connected to a negative input of an operational amplifier where in conjunction with a resistor providing negative feedback, a differentiator is formed;
wherein an output of the differentiator approximates a square wave for sampling by an analog-to-digital converter;
outputs of each compression sensor in the array is measured by the analog-to-digital converter in its turn through addressing of a multiplexer switch interposed between the differentiators and the analog-to-digital converter; and
the output of the multivibrator threshold detector is used to provide timing and polarity control information to the analog-to-digital converter through controller means to provide proper output data flow to output registers for each individual sensor element.

24. A system where a sensor array is used in concert with bolt tighteners, comprising:
a sensor array positioned between mating flanges to measure compression at locations between the flanges;
hydraulic tensioners attached to at least two bolts connecting the mating flanges;
a proportional control valve located in a pressure line to each hydraulic tensioner, the proportional control valve responsive to feedback signals from an electronic apparatus;
the electronic apparatus connected to the sensor array providing a measure of compression; and
the electronic apparatus further comprising processing to provide the feedback signals to the proportional control valves for proper installation compression.

25. A system for determining the integrity of a mechanical connection of members, comprising:
a washer-like sensor surrounding a bolt for purposes of measuring bolting force;
a washer providing compression over the area of the sensor;
a mechanical connection secured by a bolt and nut arrangement;
a measurement circuit connectable to the washer-like sensor having as it's output a measure of the washer-like sensor compression;
a display coupled to the measurement circuit providing data to an installer for use in installation; and
an apparatus for monitoring connection integrity after installation.

26. The system of claim 25 where the washer-like sensors are located in a spaced-apart array for measuring multiple bolting connections.
